(19) United States
(12) Patent Application Publication
(10) Pub. No.: US 2026/0151816 A1
(43) Pub. Date: Jun. 4, 2026

(54) ELECTRODE PLATE MANUFACTURING APPARATUS

(71) Applicant: SAMSUNG SDI CO., LTD., Yongin-si (KR)

(72) Inventor: Junyoung KIM, Yongin-si (KR)

(21) Appl. No.: 19/358,870

(22) Filed: Oct. 15, 2025

(30) Foreign Application Priority Data
Dec. 3, 2024 (KR) 10-2024-0177852

(51) Int. Cl. B21D 28/26; H01M 4/64

(52) U.S. Cl. CPC B21D 28/26; H01M 4/64

(57) ABSTRACT

An electrode plate manufacturing apparatus includes a punch member configured to cut an electrode plate, a die member spaced apart from the punch member, the die member controlling a temperature of the electrode plate and cutting the electrode plate by contacting the punch member, a first temperature control member on which is at least a portion of the electrode plate, the first temperature control member controlling a temperature of the electrode plate, and a controller electrically connected to the first temperature control member and the die member, the controller configured to control a temperature of each of the first temperature control member and the die member.

### CROSS-REFERENCE TO RELATED APPLICATION

This application claims priority to and the benefit of Korean Patent Application No. 10-2024-0177852 filed in the Korean Intellectual Property Office on Dec. 3, 2024, the entire contents of which are incorporated herein by reference.

### BACKGROUND

### 1. Field

The present disclosure relates to an electrode plate manufacturing apparatus.

### 2. Description of the Related Art

A rechargeable battery is rechargeable battery that may be repeatedly charged and discharged, unlike a primary battery that may not be recharged. A small-capacity rechargeable battery having a single pack electrode assembly is used in small portable electronic devices, such as mobile phones, camcorders, and the like, while a large-capacity rechargeable battery having several tens of electrode assemblies connected to each other is widely used as a motor-driving power source, such as in an electric scooter, a hybrid vehicle, or an electric vehicle.

The information disclosed in this section is provided only for enhancement of understanding of the background of the disclosure and therefore it may contain information that does not form the prior art.

### SUMMARY

Embodiments include an electrode plate manufacturing apparatus, including a punch member configured to cut an electrode plate, a die member spaced apart from the punch member, the die member controlling a temperature of the electrode plate and cutting the electrode plate by contacting the punch member, a first temperature control member on which is at least a portion of the electrode plate, the first temperature control member also controlling a temperature of the electrode plate, and a controller electrically connected to the first temperature control member and the die member, the controller configured to control a temperature of each of the first temperature control member and the die member.

The die member may include a contact portion in contact with the electrode plate, a mounting portion on at least one of respective sides of the contact portion, the mounting portion including an accommodation space in which a portion of the punch member is accommodated, one or more first cooling lines inside the contact portion, and one or more first heating lines inside the contact portion.

The one or more first cooling lines may include a plurality of first cooling lines, the one or more first heating lines may include a plurality of first heating lines, and the plurality of first cooling lines and the plurality of first heating lines may be alternated along a direction in which the electrode plate is conveyed in the contact portion.

The first temperature control member may include a body portion, one or more second cooling lines installed inside the body portion, and one or more second heating lines installed inside the body portion.

The one or more second cooling lines may include a plurality of second cooling lines, the one or more second heating lines may include a plurality of second heating lines, and the plurality of second cooling lines and the plurality of second heating lines may be alternated along a direction in which the electrode plate is conveyed in the body portion.

The first temperature control member may be in front of the die member based on a direction in which the electrode plate is conveyed.

An upper surface of the first temperature control member may be positioned on a same plane as an upper surface of the die member.

The first temperature control member may be a same size as the die member.

The electrode plate manufacturing apparatus may further include a second temperature control member in front of the first temperature control member based on a direction in which the electrode plate is conveyed, the second temperature control member being in contact with the electrode plate to control a temperature of the electrode plate.

The second temperature control member may have a cylindrical shape.

The punch member may include a base portion, and a cutting portion protruding from the base portion, the cutting portion being accommodated in the die member to cut the electrode plate.

The controller may be further configured to control a temperature of each of the first temperature control member and the die member by region.

The controller may be further configured to control the first temperature control member and the die member so that a middle portion of the first temperature control member has a relatively higher temperature than a remaining portion thereof and the die member based on a direction in which the electrode plate is conveyed.

The controller may be further configured to control the first temperature control member and the die member so that a middle portion of the first temperature control member has a relatively lower temperature than a remaining portion thereof and the die member based on a direction in which the electrode plate is conveyed.

The controller may be further configured to control the first temperature control member and the die member so that the first temperature control member has a relatively higher temperature than the die member.

### BRIEF DESCRIPTION OF THE DRAWINGS

Features will become apparent to those of ordinary skill in the art by describing in detail exemplary embodiments with reference to the attached drawings, in which:

FIG. 1 illustrates a cross-sectional view of an electrode plate manufacturing apparatus according to an embodiment of the present disclosure;

FIG. 2 illustrates a perspective view of an electrode plate manufacturing apparatus;

FIG. 3 illustrates an exploded perspective view of an electrode plate manufacturing apparatus;

FIG. 4 illustrates a perspective view of a process in which an uncoated region of an electrode plate is cut by a punch member and a die member to form a substrate tab;

FIG. 5 illustrates a top plan view of a process of annealing an electrode plate by controlling the temperature of each of a first temperature control member and the die member by region by a controller;

FIG. 6 illustrates a top plan view of a process of tempering an electrode plate by controlling the temperature of each of a first temperature control member and the die member by region by a controller; and

FIG. 7 illustrates a top plan view of a process of quenching an electrode plate by controlling the temperature of each of a first temperature control member and the die member by region by a controller.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described in detail with reference to the accompanying drawings. Prior to description, it should be understood that terms and words used in the specification and the appended claims should not be construed as having common and dictionary meanings, but should be interpreted as having meanings and concepts corresponding to technical ideas of the present disclosure in view of the principle that the inventor can properly define the concepts of the terms and words in order to describe his/her own embodiments as best as possible. Accordingly, since the embodiment described in the specification and the configurations shown in the drawings are merely the most preferable embodiment and configurations of the present disclosure, they do not represent all of the technical ideas of the present disclosure, and it should be understood that that various equivalents and modified examples, which may replace the embodiments, are possible when filing the present application.

It will be further understood that the terms “comprise, include,” “comprising,” and/or “including,” when used in this specification, specify the presence of the stated features, integers, steps, operations, elements, and/or components but do not preclude the presence or addition of one or more other features, integers, steps, operations, elements, components, and/or groups thereof.

When it is explained that two objects are ‘identical’, this means that these objects are ‘substantially identical’. Accordingly, the substantially identical objects may include deviations considered low in the art, for example, deviations within 5 %. In addition, when it is explained that certain parameters are uniform in a predetermined region, this may mean that the parameters are uniform in terms of an average in the corresponding region.

Although the terms “first”, “second”, and the like are used to describe various constituent elements, these constituent elements are not limited by these terms. These terms are used to distinguish one element from another, and unless stated to the contrary, a first element may be a second element.

Throughout the specification, unless stated otherwise, each element may be singular or plural.

When an element is “above (or under)” or “on (or below)” another element, the element can be on an upper surface (or a lower surface) of the other element, and intervening elements may be present between the element and the other element on (or below) the element.

In addition, when an element is referred to as “on,” “connected to,” or “coupled to” another element, the element can be directly connected or coupled to the other element, but it should be understood that intervening elements may be present between each element, or each element may be “connected”, “coupled” or “linked” to each other through another element.

As used herein, the term “and/or” includes any and all combinations of one or more of the associated listed items. Further, the use of “may” when describing embodiments of the present disclosure refers to “one or more embodiments of the present disclosure.”

Expressions such as “at least one of,” when preceding a list of elements, modify the entire list of elements and do not modify the individual elements of the list.

Throughout the specification, unless specifically stated to the contrary, the expression “A and/or B” denotes A, B, or A and B, and the expression “C to D” denotes C or more and D or less.

The expression “at least one of A, B, and C,” “at least one of A, B, or C,” and “at least one selected from the group consisting of A, B, and C” indicates only A, only B, only C, both A and B, both A and C, both B and C, all of A, B, and C, or variations thereof.

As used herein, the terms “use,” “using,” and “used” may be considered synonymous with the terms “utilize,” “utilizing,” and “utilized,” respectively. As used herein, the term “substantially,” “about,” and similar terms are used as terms of approximation and not as terms of degree, and are intended to account for the inherent variations in measured or calculated values that would be recognized by those of ordinary skill in the art.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

The terminology used herein is for the purpose of describing particular embodiments and is not intended to be limiting of the present disclosure.

Hereinafter, an electrode plate manufacturing apparatus according to an embodiment will be described in detail with reference to the accompanying drawings.

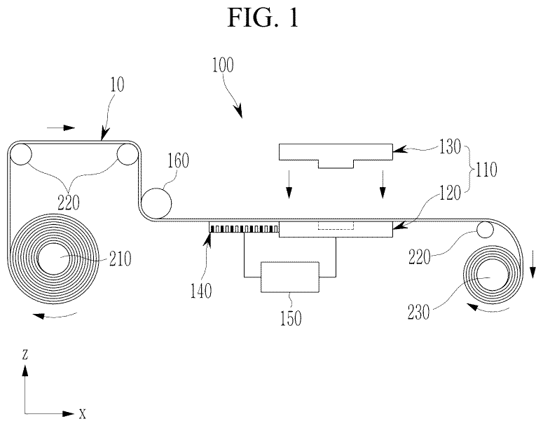

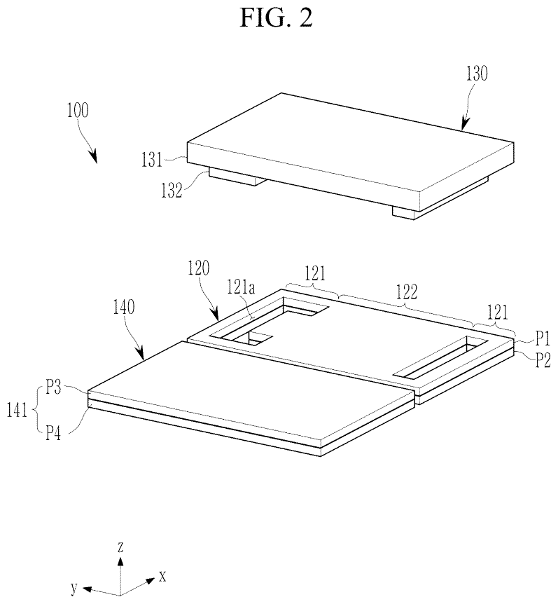

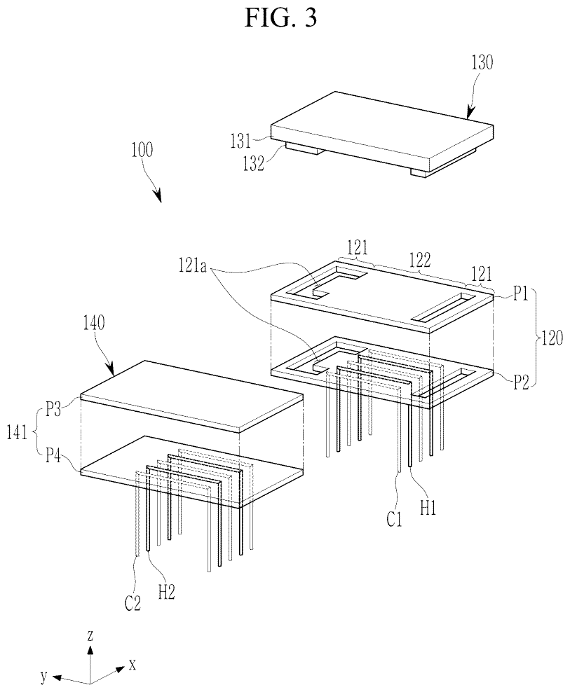

FIG. 1 illustrates a cross-sectional view of an electrode plate manufacturing apparatus according to an embodiment of the present disclosure, FIG. 2 illustrates a perspective view of an electrode plate manufacturing apparatus, and FIG. 3 illustrates an exploded perspective view of an electrode plate manufacturing apparatus.

Referring to FIG. 1 to FIG. 3, an electrode plate manufacturing apparatus 100 according to an embodiment of the present disclosure includes a punch member 130, a die member 120, a first temperature control member 140, and a controller 150.

The punch member 130 cuts an electrode plate 10. The punch member 130 for this purpose may include, for example, a base portion 131 and a cutting portion 132.

The base portion 131 may be coupled to a driving unit. For example, the punch member 130 may be lowered and raised by the driving unit, and a detailed description of the driving unit for raising and lowering the punch member 130 will be omitted.

The cutting portion 132 protrudes (e.g., in the minus Z-axis direction) from the base portion 131. The cutting portion 132 and the base portion 131 may be integrally formed. When the punch member 130 is lowered by the driving unit, the cutting portion 132 cuts the electrode plate 10 while being accommodated in the die member 120. A detailed description of the punch member 130 will be omitted.

The die member 120 is positioned to be spaced apart from the punch member 130, controls the temperature of the electrode plate 10, and cuts the electrode plate 10 as it is in contact with the punch member 130.

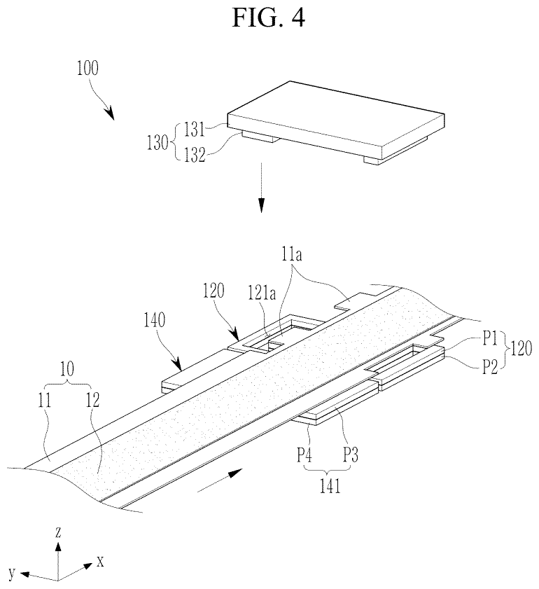

For example, a substrate tab 11a (see FIG. 4) may be generated by cutting a portion of an uncoated region 11 included in the electrode plate 10 while the punch member 130 is lowered to contact the die member 120. The uncoated region 11 is a portion of the electrode plate 10 in which an active material layer is not coated, and a detailed description thereof will be omitted.

The first temperature control member 140 is installed adjacent to the die member 120, and at least a portion of the electrode plate 10 is positioned thereon, and controls the temperature of the electrode plate 10 (e.g., the first temperature control member 140 and the die member 120 may control different regions of the electrode plate 10). The first temperature control member 140 may be positioned in front of the die member 120 based on a direction (the X-axis direction) in which the electrode plate 10 is conveyed.

The first temperature control member 140 may have a size (e.g., width, length and thickness) corresponding to (e.g., the same as) that of the die member 120. The first temperature control member 140 will be described in detail later.

The controller 150 is electrically connected to the first temperature control member 140 and the die member 120, and controls temperatures of each of the first temperature control member 140 and the die member 120. The controller 150 may be, for example, a microprocessor that controls the operation of the electrode plate manufacturing apparatus 100.

The die member 120 may include, for example, a contact portion 122, a mounting portion 121, a first cooling line C1, and a first heating line H1.

The contact portion 122 is in contact with the electrode plate 10. The contact portion 122 may be integrally formed with the mounting portion 121 to be described later.

The mounting portion 121 is positioned on at least one of both sides (e.g., opposite sides) of the contact portion 122. The mounting portion 121 and the contact portion 122 may be disposed to be perpendicular with respect to the conveying direction (the X-axis direction) of the electrode plate 10. For example, the mounting portion 121 and the contact portion 122 may be disposed along the Y-axis direction.

The mounting portion 121 includes an accommodation space 121a in which a portion of the punch member 130 is accommodated. The accommodation space 121a may have a shape corresponding to the cutting portion 132 of the punch member 130.

The mounting portion 121 and the contact portion 122 may be formed by dividing the die member 120 into regions. The die member 120 may include a first upper plate P1 and a first lower plate P2 for convenience of assembly. The mounting portion 121 and the contact portion 122 may be on the first upper plate P1 and the first lower plate P2, respectively, and the first upper plate P1 and the first lower plate P2 may have shapes corresponding to (e.g., matching) each other.

The first cooling line C1 is installed inside the contact portion 122. One or more first cooling lines C1 may be provided. The refrigerant may be conveyed through the inside of the first cooling line C1, but other conveyance approaches are possible. The first cooling line C1 (e.g., the coolant in the line) may be anything that may lower the ambient temperature.

The first heating line H1 is installed inside the contact portion 122. One or more first heating lines H1 may be provided. The first heating line H1 may be, for example, a heating coil that converts electrical energy into thermal energy, but may vary.

Some of the first heating line H1 and the first cooling line C1 may be positioned between the first upper plate P1 and the first lower plate P2. Because the die member 120 is formed of the first upper plate P1 and the first lower plate P2, the assembly of the die member 120 may be easily performed.

Meanwhile, a plurality of first cooling lines C1 may be provided, and a plurality of first heating lines H1 may be provided. In some embodiments, the first cooling lines C1 and the first heating lines H1 may be alternately positioned along the direction (X-axis direction) in which the electrode plate 10 is conveyed in the contact portion 122.

As described above, the electrode plate 10 is conveyed while maintaining contact with the die member 120. The temperature of the contact portion 122 of the die member 120 may be varied regionally by region by the first cooling line C1 and the first heating line H1.

Therefore, the die member 120 may implement the temperature of the electrode plate 10 in various ways by region. In this state, the electrode plate 10 may be cut by the die member 120 and the punch member 130 while maintaining a temperature suitable for cutting.

Meanwhile, the first temperature control member 140 described above may include, for example, a body portion 141, a second cooling line C2, and a second heating line H2.

The body portion 141 accommodates a portion of the second cooling line C2 and the second heating line H2 to be described later. The shape of the body portion 141 may be, for example, a plate shape.

The body portion 141 may include a second upper plate P3 and a second lower plate P4 for convenience of assembly. The second upper plate P3 and the second lower plate P4 may have shapes corresponding to (e.g., matching) each other.

The second cooling line C2 is installed inside the body portion 141. One or more second cooling lines C2 may be provided.

The refrigerant may be conveyed through the inside of the second cooling line C2, but other conveyance options are available. The second cooling line C2 (e.g., the coolant in the second cooling line C2) may be anything that may lower the ambient temperature.

The second heating line H2 is installed inside the body portion 141. One or more second heating lines H2 may be provided.

The second heating line H2 may be, for example, a heating coil that converts electrical energy into thermal energy, but other heating methods are possible.

Some of the first heating line H1 and the first cooling line C1 may be positioned between the first upper plate P1 and the first lower plate P2. Because the body portion 141 is formed of the first upper plate P1 and the first lower plate P2, the assembly of the first temperature control member 140 may be easily performed.

Meanwhile, a plurality of second cooling lines C2 may be provided, and a plurality of second heating lines H2 may be provided. In some embodiments, the second cooling lines C2 and the second heating lines H2 may be alternately positioned along the direction in which the electrode plate 10 is conveyed (e.g., the X-axis direction) in the body portion 141.

As described above, the electrode plate 10 is conveyed while maintaining contact with the first temperature control member 140. The temperature of a portion of the first temperature control member 140 that comes into contact with the electrode plate 10 may be varied by region by the second cooling line C2 and the second heating line H2.

Therefore, the first temperature control member 140 may implement the temperature of the electrode plate 10 in various ways by region. In this state, a specific portion of the electrode plate 10 may maintain a temperature suitable for cutting a portion adjacent thereto (a portion positioned on the mounting portion of the die member).

As described above, the first temperature control member 140 and the die member 120 may control the temperature of the electrode plate 10. To this end, the upper surface of the first temperature control member 140 may be positioned on the same plane as the upper surface of the die member 120 (e.g., the upper surfaces of the first temperature control member 140 and the die member 120 may be level with each other). Accordingly, while the electrode plate 10 is conveyed along the upper surface of each of the first temperature control member 140 and the die member 120, it may be heated by heat generated from the first temperature control member 140 and the die member 120 or cooled by cold air.

Meanwhile, the electrode plate manufacturing apparatus 100 according to an embodiment of the present disclosure may further include a second temperature control member 160 (see FIG. 1).

The second temperature control member 160 may be positioned in front of the first temperature control member 140 based on a direction in which the electrode plate 10 is conveyed and may contact the electrode plate 10 to control the temperature of the electrode plate 10. The second temperature control member 160 may have a cylindrical shape.

The temperature of the second temperature control member 160 may be varied. Accordingly, the temperature of the electrode plate 10 conveyed in contact with the second temperature control member 160 may also be varied.

The second temperature control member 160 may, for example, preheat the electrode plate 10 or lower the temperature of the electrode plate 10. The temperature of the electrode plate 10, which is varied by the second temperature control member 160, may be set to various values depending on the specifications of the rechargeable battery or the design of the electrode plate manufacturing apparatus 100.

As described above, the second temperature control member 160 may preheat or cool the electrode plate 10 to a temperature equal to that of the first temperature control member 140 before the first temperature control member 140 or die member 120 controls the temperature.

The general electrode plate 10 includes a coated region 12 coated with an active material layer and an uncoated region 11 not coated with the active material layer.

FIG. 4 illustrates a perspective view of a process in which an uncoated region of an electrode plate is cut by a punch member and a die member to form a substrate tab.

Referring to FIG. 4, the electrode plate manufacturing apparatus 100 according to the embodiment of the present disclosure cuts off a portion of the uncoated region 11 as the punch member 130 is lowered and comes into contact with the die member 120 to produce the substrate tab 11a. The first temperature control member 140 and the die member 120 described above may change the temperature of the electrode plate 10 to a state suitable for cutting.

Meanwhile, the above-described controller 150 may control the temperature of each of the first temperature control member 140 and the die member 120 by region.

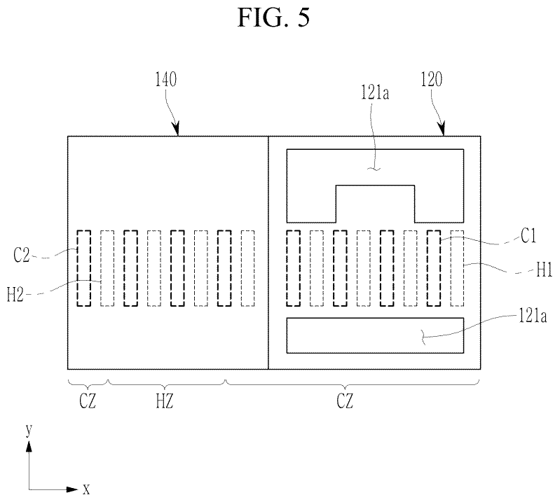

FIG. 5 illustrates a top plan view of a process of annealing an electrode plate by controlling the temperature of each of a first temperature control member and the die member by region by a controller.

Referring to FIG. 5, the controller 150 (see FIG. 1) may control the first temperature control member 140 and the die member 120 so that the middle portion of the first temperature control member 140 has a relatively higher temperature than the remaining portion thereof and the die member 120 based on the direction in which the electrode plate 10 is conveyed.

In this case, the middle portion of the first temperature control member 140 may be a high temperature region HZ. The temperature of the high temperature region HZ may range from about 180 to 220 degrees (e.g., degrees Celsius).

In some embodiments, the remaining portion of the first temperature control member 140 and the die member 120 may be a low temperature region CZ. The temperature of the low temperature region CZ may be room temperature, or may range from −20 degrees to 0 degrees (e.g., degrees Celsius).

In some embodiments, the electrode plate manufacturing apparatus 100 according to the embodiment of the present disclosure as described above may perform an annealing mode.

The annealing mode may relieve internal stress and soften the electrode plate 10 by heating the electrode plate 10 to a constant temperature and then slowly cooling it. In the process of cutting the electrode plate 10, the temperature of the electrode plate 10 may be room temperature.

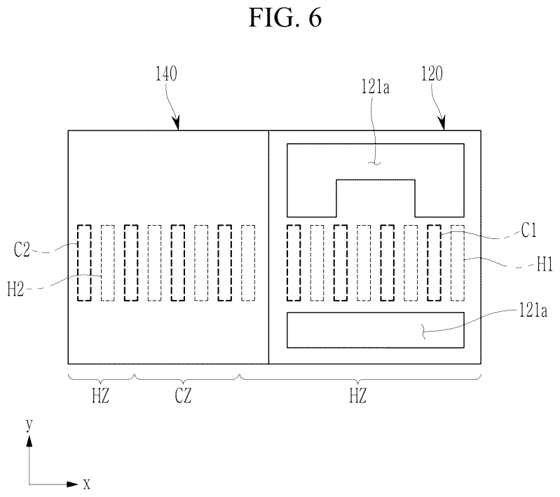

FIG. 6 illustrates a top plan view of a process of tempering an electrode plate by controlling the temperature of each of a first temperature control member and the die member by region by a controller.

Referring to FIG. 6, the controller 150 (see FIG. 1) may control the first temperature control member 140 and the die member 120 so that the middle portion of the first temperature control member 140 has a relatively lower temperature than the remaining portion thereof and the die member 120 based on the direction in which the electrode plate 10 is conveyed.

In this case, the middle portion of the first temperature control member 140 may be a low temperature region CZ. The temperature of the low temperature region CZ may be room temperature, or may range from −20 degrees to 0 degrees.

In some embodiments, the remaining portion of the first temperature control member 140 and the die member 120 may be a high temperature region HZ. The temperature of the high temperature region HZ may range from about 180 to 220 degrees.

In some embodiments, the electrode plate manufacturing apparatus 100 according to an embodiment of the present disclosure as described above may perform a tempering mode.

The tempering mode may increase hardness by heating the electrode plate 10 at a high temperature and then rapidly cooling it, and then reheating it to secure high strength and appropriate ductility. In the process of cutting the electrode plate 10, the temperature of the electrode plate 10 may be higher than room temperature.

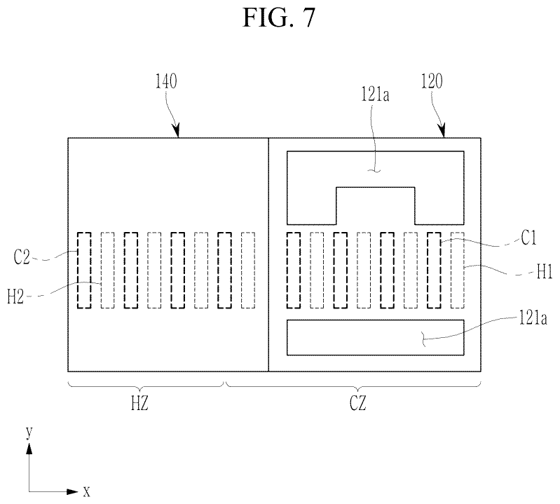

FIG. 7 illustrates a top plan view of a process of quenching an electrode plate by controlling the temperature of each of a first temperature control member and the die member by region by a controller.

Referring to FIG. 7, the controller 150 (see FIG. 1) may control the first temperature control member 140 and the die member 120 so that the first temperature control member 140 has a relatively higher temperature than the die member 120.

In this case, the first temperature control member 140 may be the high temperature region HZ. The temperature of the high temperature region HZ may range from about 180 to 220 degrees.

In some embodiments, the die member 120 may be the low temperature region CZ. Here, not only the entire die member 120 but also a portion of the first temperature control member 140 adjacent to the die member 120 may be the low temperature region CZ.

The range of the low temperature region CZ may vary depending on the size of the electrode plate 10 or the design of the electrode plate manufacturing apparatus 100 according to an embodiment of the present disclosure. The temperature of the low temperature region CZ may be room temperature, or may range from −20 degrees to 0 degrees.

In some embodiments, the electrode plate manufacturing apparatus 100 according to an embodiment of the present disclosure as described above may perform a quenching mode. Because the quenching mode may improve the hardness by heating the electrode plate 10 to a high temperature and then rapidly cooling it, cutting of the electrode plate 10 at high hardness may be performed.

The rechargeable battery includes an electrode plate, and the electrode plate is generally manufactured by processing it with a shear mold. The mold for this includes a punch and a die.

When the punch is lowered and comes into contact with the die, a portion of the electrode plate is cut into a specific shape. At this time, defects such as burrs or threads may occur at the cut portion of the electrode plate. If charging and discharging are repeated in a rechargeable battery including such an electrode plate, problems may occur in the stability of the rechargeable battery.

As described above, in the electrode plate manufacturing apparatus 100 according to the embodiment of the present disclosure, the electrode plate 10 (see FIG. 4) may be maintained at a temperature suitable for cutting by the die member 120 and the first temperature control member 140. Accordingly, the electrode plate 10 (see FIG. 4) may be cut into the target shape, thereby reducing the defect rate. Accordingly, rechargeable battery productivity may also be improved.

The electrode plate manufacturing apparatus according to the present disclosure may maintain the temperature of the electrode plate at a temperature suitable for cutting by using a die member and a first temperature control member. Accordingly, the defect rate may be reduced by cutting the electrode plate into the target shape. Accordingly, rechargeable battery productivity may also be improved.

Although several embodiments of the present disclosure have been described above, while this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims. Therefore, those skilled in the art will understand that various modifications and other equivalent embodiments of the present disclosure are possible. Consequently, the true technical protective scope of the present disclosure must be determined based on the technical spirit of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### Description of Symbols

100: electrode plate manufacturing apparatus
120: die member
122: contact portion
121: mounting portion
130: punch member
131: base portion
132: cutting portion
140: first temperature control member
141: body portion
150: controller
160: second temperature control member
C1: first cooling line
H1: first heating line
P1: first upper plate
P2: first lower plate
C2: second cooling line
H2: second heating line
P3: second upper plate
P4: second lower plate

What is claimed is:

1. An electrode plate manufacturing apparatus, comprising:
a punch member configured to cut an electrode plate;
a die member spaced apart from the punch member, the die member controlling a temperature of the electrode plate and cutting the electrode plate by contacting the punch member;
a first temperature control member on which is at least a portion of the electrode plate, the first temperature control member also controlling a temperature of the electrode plate; and
a controller electrically connected to the first temperature control member and the die member, the controller configured to control a temperature of each of the first temperature control member and the die member.

2. The electrode plate manufacturing apparatus as claimed in claim 1, wherein the die member includes:
a contact portion in contact with the electrode plate;
a mounting portion on at least one of respective sides of the contact portion, the mounting portion including an accommodation space in which a portion of the punch member is accommodated;
one or more first cooling lines inside the contact portion; and
one or more first heating lines inside the contact portion.

3. The electrode plate manufacturing apparatus as claimed in claim 2, wherein:
the one or more first cooling lines include a plurality of first cooling lines,
the one or more first heating lines include a plurality of first heating lines, and
the plurality of first cooling lines and the plurality of first heating lines are alternated along a direction in which the electrode plate is conveyed in the contact portion.

4. The electrode plate manufacturing apparatus as claimed in claim 1, wherein the first temperature control member includes:
a body portion;
one or more second cooling lines installed inside the body portion; and
one or more second heating lines installed inside the body portion.

5. The electrode plate manufacturing apparatus as claimed in claim 4, wherein:
the one or more second cooling lines include a plurality of second cooling lines,
the one or more second heating lines include a plurality of second heating lines, and
the plurality of second cooling lines and the plurality of second heating lines are alternated along a direction in which the electrode plate is conveyed in the body portion.

6. The electrode plate manufacturing apparatus as claimed in claim 1, wherein the first temperature control member is in front of the die member based on a direction in which the electrode plate is conveyed.

7. The electrode plate manufacturing apparatus as claimed in claim 1, wherein an upper surface of the first temperature control member is positioned on a same plane as an upper surface of the die member.

8. The electrode plate manufacturing apparatus as claimed in claim 1, wherein the first temperature control member is a same size as the die member.

9. The electrode plate manufacturing apparatus as claimed in claim 1, further comprising a second temperature control member in front of the first temperature control member based on a direction in which the electrode plate is conveyed, the second temperature control member being in contact with the electrode plate to control a temperature of the electrode plate.

10. The electrode plate manufacturing apparatus as claimed in claim 9, wherein the second temperature control member has a cylindrical shape.

11. The electrode plate manufacturing apparatus as claimed in claim 1, wherein the punch member includes:
a base portion; and
a cutting portion protruding from the base portion, the cutting portion being accommodated in the die member to cut the electrode plate.

12. The electrode plate manufacturing apparatus as claimed in claim 1, wherein the controller is further configured to control a temperature of each of the first temperature control member and the die member by region.

13. The electrode plate manufacturing apparatus as claimed in claim 12, wherein the controller is further configured to control the first temperature control member and the die member so that a middle portion of the first temperature control member has a relatively higher temperature than a remaining portion thereof and the die member based on a direction in which the electrode plate is conveyed.

14. The electrode plate manufacturing apparatus as claimed in claim 12, wherein the controller is further configured to control the first temperature control member and the die member so that a middle portion of the first temperature control member has a relatively lower temperature than a remaining portion thereof and the die member based on a direction in which the electrode plate is conveyed.

15. The electrode plate manufacturing apparatus as claimed in claim 12, wherein the controller is further configured to control the first temperature control member and the die member so that the first temperature control member has a relatively higher temperature than the die member.
